(19) United States
(12) Patent Application Publication
(10) Pub. No.: US 2010/0125916 A1
(43) Pub. Date: May 20, 2010

(54) APPARATUS AND METHOD FOR CONTROLLING CONTENT

(75) Inventors: Yun-ho CHOI, Seoul (KR); Yong-Kuk YOU, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/564,217

(22) Filed: Sep. 22, 2009

(30) Foreign Application Priority Data
Nov. 18, 2008 (KR) 10-2008-0114778

(51) Int. Cl. G06F 21/00

(52) U.S. Cl. 726/31

(57) ABSTRACT

An apparatus and method for controlling content are provided. A memory which stores storage medium information regarding a storage medium, and a main control unit which groups a plurality of contents in the storage medium into a plurality of groups, allocates a group nonce to each group, stores the group nonce in the storage medium, and if a move of at least one content item of the plurality of content items is requested, controls the move of the content item based on whether the storage medium information contains an identifier or a group nonce of a first target group including the requested content item.

### CROSS-REFERENCE TO RELATED APPLICATIONS

This application claims priority from Korean Patent Application No. 10-2008-0114778, filed on Nov. 18, 2008 in the Korean Intellectual Property Office, the disclosure of which is incorporated herein by reference in its entirety.

### BACKGROUND OF THE INVENTION

1. Field of the Invention

Apparatuses and methods consistent with the present invention relate to controlling content, and more particularly, to controlling content so as to prevent illegal use of content having a copy limit.

2. Description of the Related Art

Recently, products for receiving broadcast content and storing the broadcast content in storage media have been vigorously developing and some of them are used. If content stored in a storage medium has copy control information, the content can be moved to another storage medium. “Move” means that the content is copied from the original storage medium to another storage medium and is deleted from the original storage medium.

If the content is moved as described above, the content can be illegally copied using a clone attack. In a clone attack, before the content is moved, the original storage medium is backed up, and after the content is moved, the content is played back using the backed-up storage medium, so that the content can be illegally copied.

Therefore, in order to prevent content from being illegally distributed using illegal copies, there is a need for methods for preventing content from being played back in other storage media when content which is allowed to be copied just one time is moved to another storage medium.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention provides an apparatus and method for controlling content so as to prevent the content having a copy limit of once from being illegally copied and from being played back in two or more storage media.

According to an exemplary aspect of the present invention, there is provided a content control apparatus including a memory which stores storage medium information regarding a storage medium, and a main control unit which groups a plurality of contents to be stored in the storage medium into a plurality of groups, allocates a group nonce to each group, stores the group nonce in the storage medium, and if a move of at least one content of the plurality of contents is requested, controls the move of the content taking into consideration whether or not the storage medium information contains an identifier or a group nonce of a first target group including the requested content.

If the move of the at least one content of the plurality of contents is requested, the main control unit may determine whether or not the storage medium information contains the identifier of the first target group, and if the storage medium information contains the identifier of the first target group, the main control unit may allow the move of the content according to whether or not the group nonce of the first target group in the storage medium information is the same as the group nonce of the first target group stored in the storage medium.

If the group nonce of the first target group in the storage medium information is the same as the group nonce of the first target group stored in the storage medium, the main control unit may allow the move of the content.

If the content is moved to another storage medium, the main control unit may update the group nonce of the first target group in the storage medium information and the group nonce of the first target group stored in the storage medium.

If the storage medium information does not contain the identifier of the first target group, the main control unit may move the content to another storage medium.

If the content is moved to another storage medium, the main control unit may update the group nonce of the first target group stored in the storage medium, and add the updated group nonce and the identifier of the first target group to the storage medium information and stores the updated storage medium information in the memory.

Initial information stored in the memory may not contain the group nonce of each group.

If the content is moved to another storage medium, the main control unit may delete the content from the storage medium.

If playback of content stored in the storage medium is requested, the main control unit may determine whether or not the storage medium information stored in the memory contains an identifier of a second target group including the requested content, and if the storage medium information stored in the memory contains the identifier of the second target group and if a group nonce of the second target group in the storage medium information stored in the memory is the same as a group nonce of the second target group stored in the storage medium, the main control unit may play back the content.

If the storage medium information stored in the memory does not contain the identifier of the second target group, the main control unit may play back the requested content.

According to another exemplary aspect of the present invention, there is provided a content controlling method including grouping a plurality of contents to be stored in a storage medium into a plurality of groups, generating a group nonce for each group, and storing the group nonce in the storage medium, storing storage medium information regarding the storage medium in a memory, and if a move of at least one content of the plurality of contents is requested, controlling the move of the content taking into consideration whether or not the storage medium information contains an identifier or a group nonce of a first target group including the requested content.

The controlling operation may include if the move of the at least one content of the plurality of contents is requested, determining whether or not the storage medium information contains the identifier of the first target group, and if the storage medium information contains the identifier of the first target group, allowing the move of the content according to whether or not the group nonce of the first target group in the storage medium information is the same as the group nonce of the first target group stored in the storage medium.

In the allowing operation, if the group nonce of the first target group in the storage medium information is the same as the group nonce of the first target group stored in the storage medium, the move of the content may be allowed.

The method may further include moving the content to another storage medium, and updating the group nonce of the first target group in the storage medium information and the group nonce of the first target group stored in the storage medium.

The method may further include if the storage medium information does not contain the identifier of the first target group, moving the content to another storage medium.

After the moving operation, the method may further include updating the group nonce of the first target group stored in the storage medium, and adding the updated group nonce and the identifier of the first target group to the storage medium information and stores the updated storage medium information in the memory.

The method may further include if the content is moved to another storage medium, deleting the content from the storage medium.

The method may further include if playback of content stored in the storage medium is requested, determining whether or not the storage medium information stored in the memory contains an identifier of a second target group including the requested content, if the storage medium information stored in the memory contains the identifier of the second target group, determining whether or not a group nonce of the second target group in the storage medium information stored in the memory is the same as a group nonce of the second target group stored in the storage medium, and if the group nonce of the second target group in the storage medium information stored in the memory is the same as the group nonce of the second target group stored in the storage medium, playing back the requested content

The method may further include if the storage medium information stored in the memory does not contain the identifier of the second target group, playing back the requested content.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 schematically illustrates storage medium information stored in a memory and grouped content stored in a storage medium;

FIGS. 2A and 2B illustrate the structure of storage medium information stored in a memory of a content control apparatus;

FIG. 3 illustrates the structure of a content information file according to an exemplary embodiment of the present invention;

FIG. 4 illustrates content group information stored in a storage medium;

FIG. 5 is a block diagram illustrating a content control apparatus which limits the use of content according to an exemplary embodiment of the present invention;

FIG. 6 is a flow chart illustrating a content controlling method for moving content according to an exemplary embodiment of the present invention; and

FIG. 7 is a flow chart illustrating a content controlling method for playing back content according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

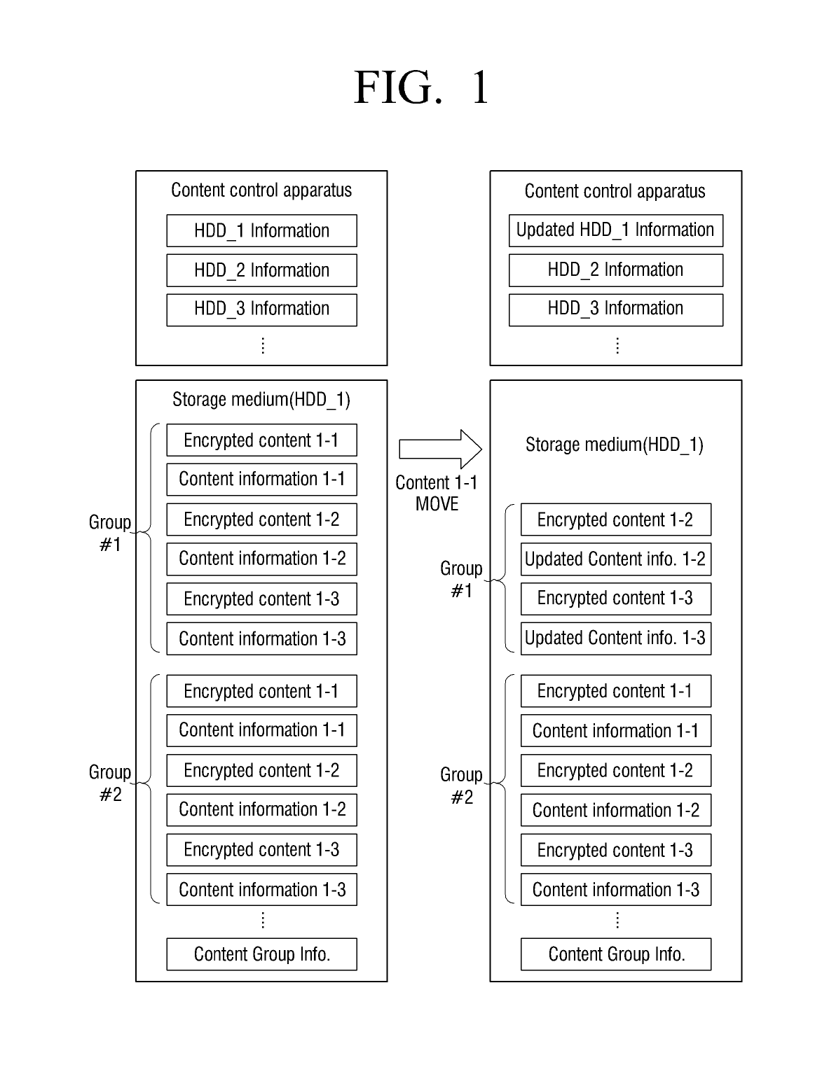

FIGS. 1 to 4 illustrate a method for storing content in a content control apparatus according to an exemplary embodiment of the present invention.

The content control apparatus stores received content in a storage medium, and limits the use of the stored content such as copy or playback. The storage medium may be an embedded storage medium or an external storage medium, for example, a mass storage medium such as a hard disk drive (HDD).

As illustrated in FIG. 1, the content control apparatus stores content in storage media which are connected thereto, and stores information regarding the storage media (referred to hereinafter as the “storage medium information”) in a memory of the content control apparatus.

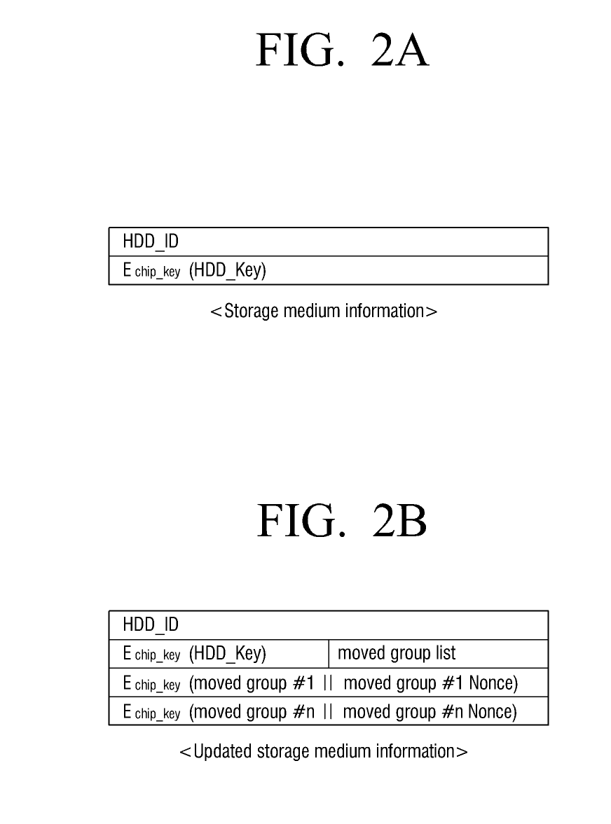

FIGS. 2A and 2B illustrate the structure of storage medium information stored in the memory of the content control apparatus.

As illustrated in FIG. 2A, if a storage medium is an HDD, storage medium information may include an identifier (HDD_ID) and a unique key (HDD_Key) of the storage medium. The unique key (HDD_Key) of the storage medium is provided by the content control apparatus, and may be encrypted and stored using a device key (chip_key) of the content control apparatus. The device key (chip_key) is a unique key for each inner set of the content control apparatus.

FIG. 3 illustrates the structure of a content information file according to an exemplary embodiment of the present invention.

A content information file includes information regarding content. The content control apparatus generates a content information file for each set of content, and binds and stores the content information file with the corresponding content. Accordingly, if the content is moved to another storage medium, the content information file as well as the content are deleted from an original storage medium.

As illustrated in FIG. 3, the content information file may include an encrypted content key (EHDD_key(content_key)), an identifier of a group including the content (Group Number), a nonce of the group including the content (Group Nonce), copy control information (Copy Control Information (CCI)), and a MAC(Message Authentication Code).

The content key (EHDD_key(content_key)) is encrypted using a unique key (HDD_Key) of a storage medium to store the content, so the exposure of the content key can be prevented.

The identifier of a group including the content (Group Number) is information to identify the group including the content, and may be a name or number of the group. Hereinafter, it is assumed that the group identifier is a group number.

The nonce of the group including the content (Group Nonce) is a value generated for the group by the content control apparatus. That is, a single group nonce is allocated to a single group, so contents in the same group have the same group nonce. A nonce allocated to a single group may be updated, and does not overlap with the previous nonce. In addition, a group nonce may be encrypted using the device key (chip_key) of the content control apparatus and is stored.

The copy control information (CCI) is information to limit copies of the content, and may be divided into “limitless copy”, “one copy”, “no more copies”, and “no copy”, one of which is set for the content. These values for copy control information are described as part of an exemplary embodiment; as such, the claimed invention is not limited to these particular values.

The (Message Authentication Code)MAC is a signature to prevent the content information file or the content from being altered and to check integrity.

Hereinafter, description of content having a copy limit of “once” is given as an example.

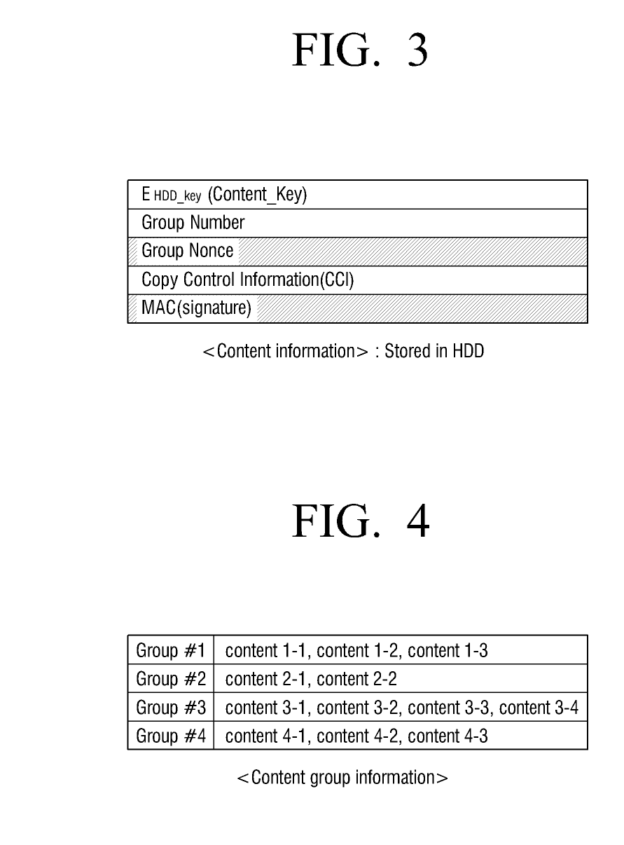

FIG. 4 illustrates content group information stored in a storage medium. The content group information allocates a group to content stored in the storage medium, and includes identification information of content in each group. Accordingly, the content control apparatus obtains the existing group identifiers with reference to the content group information as illustrated in FIG. 4, and determines a group into which it will put the content to be stored in the storage medium. Referring to FIG. 4, a first content group (Group #1) includes content 1-1, content 1-2, and content 1-3, so content 1-1, content 1-2, and content 1-3 share the same group nonce.

Returning to FIG. 1, for example, if first content (content1-1) stored in a first content group (Group #1) of a first storage medium (HDD_1) is moved to another storage medium (for example, HDD_2), the content control apparatus deletes the first content (Encrypted content1-1) and the first content information file (content info.1-1) from HDD_1, and updates storage medium information (HDD_1 information) regarding HDD_1 stored in a memory, and the remaining content information files of the first content group (Group #1) stored in HDD_1.

More specifically, if the first content is deleted, the content control apparatus updates a group nonce of the first content group (Group #1) including the first content, so that group nonces of the remaining content information files in the first content group (Group #1) can be updated to be the same value. In addition, MAC values of the remaining content information files can be updated based on the updated group nonces. ‘Updated Content info. 1-2’ and ‘Updated Content info. 1-3’ in FIG. 1 indicate content information files for which a group nonce or a MAC value is updated.

The content control apparatus encrypts an identifier (Group Number) and the updated group nonce of the first content group (Group #1) from which the first content is deleted using a chip key, and adds the encrypted identifier and group nonce to the storage medium information as illustrated in FIG. 2B. In addition, the content control apparatus adds the identifier of a group which previously included the content to a moved content group list.

The moved content group list can be included in the storage medium information if any content stored in the first to nth storage media is initially deleted. Accordingly, after the first content is deleted, Echip_key(moved group #1∥moved group #1 Nonce) can be added to the storage medium information of HDD_1, so that the storage medium information of HDD_1 can be updated as illustrated in FIG. 2B.

The content control apparatus according to the exemplary embodiment of the present invention limits the use of content stored in the storage media managed by the content control apparatus using a group identifier or a group nonce. The ‘use’ of content may be, e.g., a move of content, that is, a copying of the content. If a group identifier included in a content information file of content receiving a move request is included in the moved content group list, or if a group nonce included in a content information file of content receiving a move request is the same as a group nonce of the same group included in the storage medium information, the use of the content is allowed. Accordingly, the content control apparatus can protect itself against disk cloning attacks.

For example, even if an attacker backs up HDD_1 having the structure as illustrated on the left side of FIG. 1 using a disk cloning method, copies the first content from HDD_1 to another storage medium, accesses the content control apparatus, and requests playback of the backed-up content, the content control apparatus refuses playback of the first content. This is because after the first content is copied, a group nonce of the first content group including the first content is updated and added to the storage medium information, so the updated group nonce is different from a group nonce (Group Nonce #1) included in the first content information file of the backed-up storage medium.

Since group nonces of the remaining content information files stored in the first content group (Group #1) are updated to be the same group nonce as the updated group nonce, playback or copy of the remaining content is not interrupted.

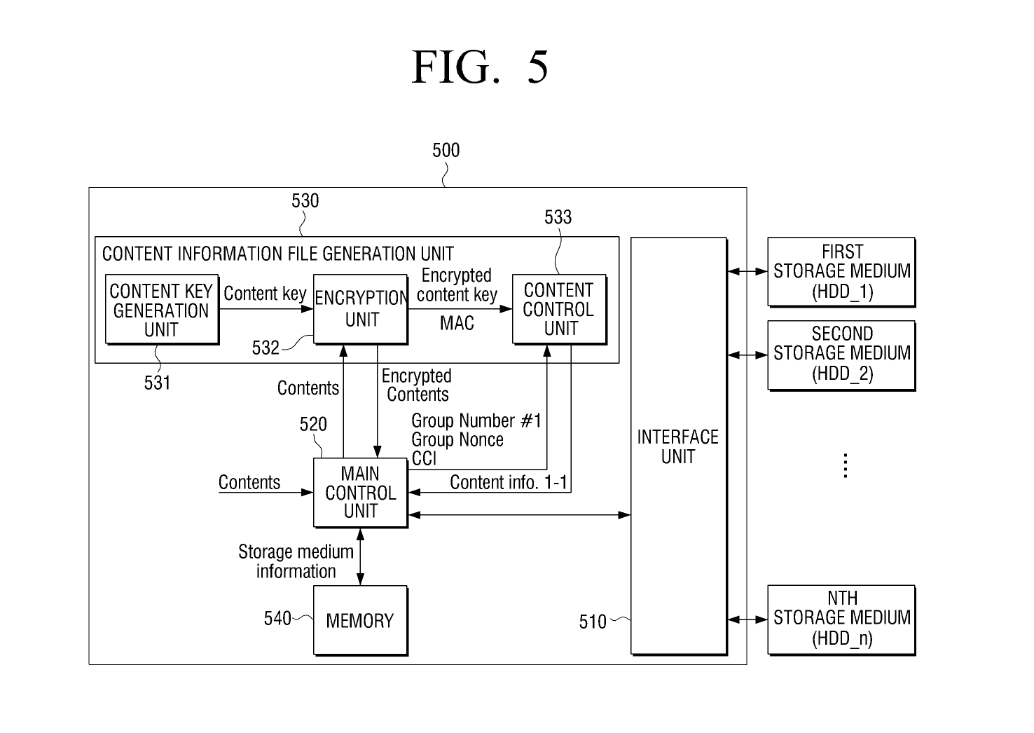

FIG. 5 is a block diagram illustrating a content control apparatus which limits the use of content according to an exemplary embodiment of the present invention.

Referring to FIGS. 1 to 5, the content control apparatus 500 may include an interface unit 510, a main control unit 520, a content information file generation unit 530, and a memory 540.

The interface unit 510 enables first to nth storage media (HDD_1, . . . , and HDD_n, where n is a constant) to communicate with the content control apparatus 500 wirelessly or via a wired line. An HDD is described here as an example of a storage medium, but diverse kinds of attachable storage devices can be used as storage media.

The main control unit 520 allocates a group to content to be stored in at least one storage medium, and allocates a group nonce to the group. More specifically, if the content is stored in the first storage medium (HDD_1), the main control unit 520 identifies a content group information file stored in the first storage medium (HDD_1) as illustrated in FIG. 4 and determines a group to put the content into.

If a group to put the content into is an existing group, the main control unit 520 allocates to the content the group nonce which has already been allocated to the existing group. If a group to put the content into is a new group, the main control unit 520 allocates a new group nonce to the new group and the content. The group nonce allocated to the content is recorded in the content information file.

For example, if the first content group (Group #1) has a space for storing the content, the main control unit 520 stores the content in the first content group (Group #1). Accordingly, the content information file can have a group identifier and a group nonce of the first content group (Group #1). Alternatively, if a new group (for example, Group #5) is allocated to the content to be stored, the main control unit 520 adds the new group (Group #5) to the content group information, and allocates a new group nonce to the content and the new group (Group #5).

The main control unit 520 identifies CCI included in the content, and provides a content control unit 533 with the CCI, and the group identifier and group nonce of the first content group (Group #1) or the fifth content group (Group #5).

The content information file generation unit 530 generates a content information file including information regarding content to be stored in at least one storage medium. The content information file generation unit 530 may include a content key generation unit 531, an encryption unit 532, and a content control unit 533. Hereinbelow, it is assumed that the content is stored in the first storage medium (HDD_1).

The content key generation unit 531 generates a content key (content_key) to encrypt the content to be stored in the first storage medium (HDD_1). A content key (content_key) may be generated for each content.

The encryption unit 532 encrypts the content using the content key (content_key), encrypts the content key (content_key) using a unique key (HDD_key) of the first storage medium (HDD_1), and generates a MAC value. In addition, the encryption unit 532 encrypts a unique key (HDD_key) of each storage medium (HDD_1, . . . , and HDD_n) using a device key (chip key) of the content control apparatus 500, and encrypts and stores a group nonce of each group (Group #1, . . . , and Group #k, where k is a constant) using the device key (chip key) of the content control apparatus 500.

The content control unit 533 generates a content information file (Content information 1-1) of the first content as illustrated in FIG. 3. The content information file includes the group identifier (Group #1) and group nonce of the first content group (Group #1) storing the content, the content key (EHDD_key(content_key)) encrypted by the encryption unit 532, the CCI, and the MAC value.

A content key file may include the encrypted device key and nonce of the storage medium, a content ID, and copy control information regarding the content, and may also include a MAC or a signature so as to check integrity.

The main control unit 520 binds the encrypted content (Encrypted content1-1) with the content information file (Content information 1-1), and stores the bound content in the first content group (Group #1) of the first storage medium (HDD_1).

The main control unit 520 generates the storage medium information (HDD_1 information) which includes the identifier (HDD_ID) and the encrypted unique key (Echip_key(HDD_key)) of the first storage medium as illustrated in FIG. 2, and stores the storage medium information in the memory 540. The main control unit 520 generates and stores storage medium information (HDD_1 information, . . . , and HDD_n information) for the storage media (HDD_1, . . . , and HDD_n) which are connected to the interface unit 510. Initially generated storage medium information includes only an identifier and an encrypted key of the storage medium, and does not include a group nonce for each group. Accordingly, if it is requested that the content is initially moved or played back, it can be more rapidly determined whether or not it is allowable to move or play back the content.

If a move of content is requested, the main control unit 520 controls the move of the content taking into consideration whether storage medium information includes a group identifier or a group nonce of a group including the content (Group Number). Hereinbelow, it is assumed that content to be moved is first content, a group including the first content is a first target group (Group #1), and a storage medium storing the first content is a first storage medium (HDD_1).

More specifically, if a move of the first content is requested, the main control unit 520 determines whether or not storage medium information (HDD_1 info.) or a moved content group list of updated storage medium information (updated HDD_1 info.) includes an identifier of the first target group (Group #1).

If the storage medium information (HDD_1 info.) or the moved content group list of the updated storage medium information (updated HDD_1 info.) includes the identifier of the first target group (Group #1), it means that other content in the first target group (Group #1) has been moved. Accordingly, the main control unit 520 allows the move of the first content according to whether a group nonce of the first target group (Group #1) included in the storage medium information (HDD_1 info.) is the same as a group nonce of the first target group (Group #1) stored in the first storage medium (HDD_1). The main control unit 520 can identify the group nonce of the first target group (Group #1) stored in the first storage medium (HDD_1) from content information file of the first content stored in the first storage medium (HDD_1).

If the group nonce of the first target group (Group #1) included in the storage medium information (HDD_1 info.) is the same as the group nonce of the first target group (Group #1) stored in the first storage medium (HDD_1), the main control unit 520 allows the move of the first content. If the first content is moved to another storage medium, the main control unit 520 updates the group nonce of the first target group (Group #1) (or the group nonces of the remaining content information files in the first target group) stored in the first storage medium (HDD_1) so that the remaining content information files in the first target group can have the same group nonce, and the main control unit 520 adds the updated group nonce and a group identifier, in which a group nonce is updated, to the storage medium information (HDD_1 info.) in the memory 540.

If the storage medium information (HDD_1 info.) in the memory 540 does not include the identifier of the first target group (Group #1), it means that no other content in the first target group (Group #1) has been moved. Accordingly, the main control unit 520 moves the first content to another storage medium.

If the first content is moved to another storage medium (for example, a second storage medium), the main control unit 520 updates the group nonce of the first target group (Group #1) stored in the first storage medium (HDD_1). That is, the main control unit 520 updates the group nonces of the remaining content information files in the first target group to have the same value. In addition, the main control unit 520 generates a group identifier of the moved first content (that is, an identifier of the first target group), and adds the updated group nonce and the group identifier to the storage medium information stored in the memory 540 as illustrated in FIG. 2B, so that the storage medium information (HDD_1 info.) can be updated. If the storage medium information (HDD_1 info.) can be updated, the main control unit 520 can update a MAC value in the content information file based on the updated group nonce.

If the first content is moved to another storage medium, the main control unit 520 deletes the first content from the storage medium (HDD_1).

If playback of content which is stored in a second target group of a storage medium is requested, the main control unit 520 determines whether or not storage medium information stored in the memory 540 includes an identifier of the second target group including the requested content. If the requested content is stored in a second storage medium (HDD_2), the used storage medium information is second storage medium information (HDD_2 info.).

In particular, if the identifier of the second target group is on a moved group list of the storage medium information (HDD_2 info.), the main control unit 520 plays back the content when a group nonce of the second target group in the storage medium information stored in the memory 540 is the same as a group nonce of the second target group stored in the second storage medium (HDD_2).

On the contrary, if the identifier of the second target group is not included in the storage medium information (HDD_2 info.), the main control unit 520 plays back the content. In particular, if the identifier of the second target group is on the moved group list, the main control unit 520 plays back the content.

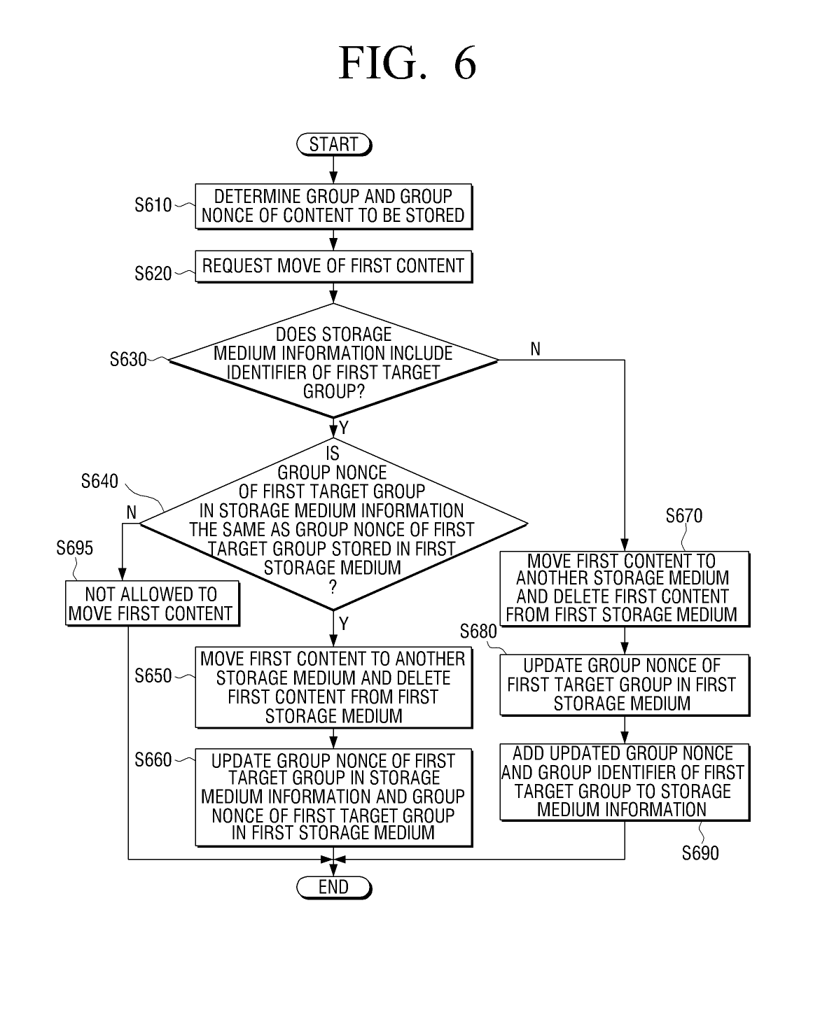

FIG. 6 is a flow chart illustrating a content controlling method for moving content according to an exemplary embodiment of the present invention.

Referring to FIGS. 1 to 6, the main control unit 520 identifies a content group information file as illustrated in FIG. 4, determines a group to put received content into, and sets a group nonce of the determined group to be a group nonce of the content (S610). The content is received via a broadcasting channel or an external set-top box, and is stored in a storage medium designated by a user or a certain storage medium. In operation S610, if the determined group is a new group, the main control unit 520 allocates a new group nonce, or if the determined group is an existing group, the main control unit 520 uses a group nonce of the existing group.

If the move of at least one content from among content stored in storage media (HDD_1, . . . , and HDD_n) is requested (S620), the main control unit 520 determines whether an identifier of a group including the content is included in corresponding storage medium information stored in the memory 540 (S630). Hereinbelow, it is assumed that the content to be moved is first content, a group including the first content is a first target group (Group #1), and a storage medium storing the first content is a first storage medium.

If the identifier of the group including the content is included in the corresponding storage medium information stored in the memory 540, the main control unit 520 allows the move of the first content according to whether a group nonce of the first target group (Group #1) included in the storage medium information (HDD_1 info.) is the same as a group nonce of the first target group (Group #1) stored in the first storage medium (HDD_1) (S640).

If it is determined in operation S640 that the group nonce of the first target group (Group #1) included in the storage medium information (HDD_1 info.) is the same as the group nonce of the first target group (Group #1) stored in the first storage medium (HDD_1), the main control unit 520 allows the move of the first content. Accordingly, the main control unit 520 moves the first content to another storage medium, and deletes the first content from the first storage medium (HDD_1) (S650).

The main control unit 520 updates the group nonce of the first target group (Group #1) in the storage medium information (HDD_1 info.) stored in the memory 540, and the group nonce of the first target group (Group #1) stored in the first storage medium (HDD_1) so as to have the same group nonce (S660).

If it is determined in operation S630 that the identifier of the first target group (Group #1) is not included in the storage medium information (HDD_1 info.) stored in the memory 540, it means that any other content in the first target group (Group #1) has not been moved. Accordingly, the main control unit 520 moves the first content to another storage medium, and deletes the first content from the first storage medium (HDD_1) (S670).

After operation S670, the main control unit 520 updates the group nonce of the first target group (Group #1) in the first storage medium (HDD_1) (S680), generates a group identifier of the first content (that is, an identifier of the first target group), and adds the updated group nonce and the group identifier of the first target group (Group #1) to the storage medium information (HDD_1 info.) in the memory 540 (S690).

If it is determined in operation S640 that the group nonce of the first target group (Group #1) included in the storage medium information (HDD_1 info.) is not the same as the group nonce of the first target group (Group #1) stored in the first storage medium (HDD_1), the main control unit 520 determines that it is not allowed to move the first content (S695). The discrepancy between the group nonces indicates that the first content has been copied or backed up using a cloning attack, and that a move of the backed-up first content is requested.

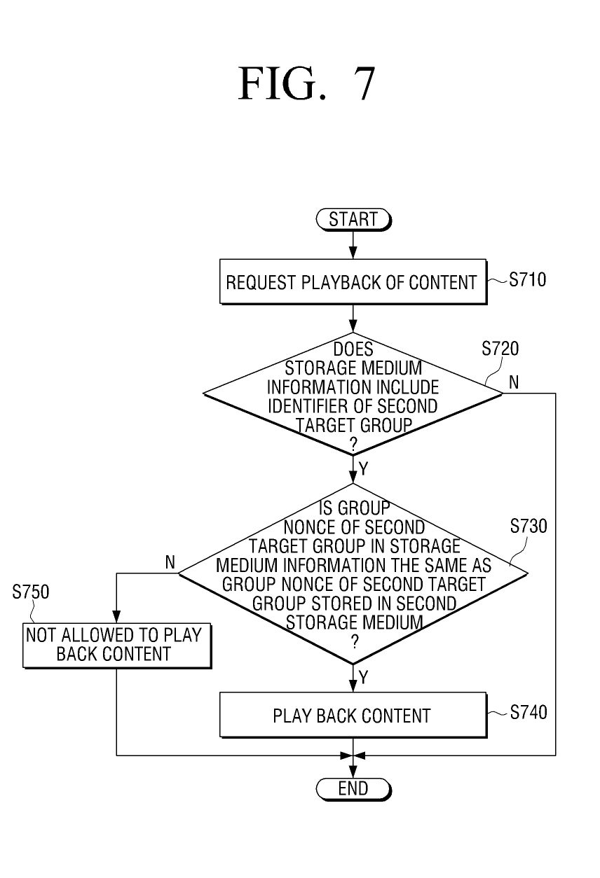

FIG. 7 is a flow chart illustrating a content controlling method for playing back content according to an exemplary embodiment of the present invention.

Referring to FIGS. 1 to 7, if playback of content which is stored in one of storage media (HDD_1, . . . , and HDD_n) is requested (S710), the main control unit 520 determines whether or not storage medium information stored in the memory 540 includes an identifier of a second target group (Group #2) including the requested content (S720). If the requested content is stored in a second storage medium (HDD_2), the main control unit 520 determines whether or not storage medium information (HDD_2 info.) includes the identifier of the second target group (Group #2).

If a moved group list of the storage medium information (HDD_2 info.) includes the identifier of the second target group (Group #2), when a group nonce of the second target group (Group #2) in the storage medium information (HDD_2 info.) of the memory 540 is the same as a group nonce of the second target group in the second storage medium (HDD_2) (S730), the main control unit 520 plays back the content (S740).

Alternatively, if the storage medium information (HDD_2 info.) in the memory 540 does not include the identifier of the second target group (Group #2), the main control unit 520 plays back the content (S740).

In operation S730, if a group nonce of the second target group (Group #2) in the storage medium information (HDD_2 info.) of the memory 540 is not the same as a group nonce of the second target group in the second storage medium (HDD_2), the main control unit 520 determines that the playback of the content backed-up using cloning attack is requested, and thus does not play back the content (S750).

According to exemplary embodiments of the present invention, initial storage medium information stored in the memory 540 does not include a group nonce, and after certain content is moved, the storage medium information can have a group nonce of a group which included the content. Accordingly, when a move of content is requested, it can be more rapidly determined whether or not it is allowable to move the content. So can it when playback of content is requested.

In addition, a nonce is allocated group by group. After content is moved, group nonces of the remaining content information files of a group which included the moved content are updated, so the group nonce can be rapidly updated.

As can be appreciated from the above description, if a cloning attack is performed on certain content and the content has CCI allowing a copy limit of “once”, the copy control apparatus determines whether or not a group nonce of the content is stored in a memory of the content control apparatus. Accordingly, it can be determined whether or not the content control apparatus limits the use of the content using a content controlling method by determining whether or not the group nonce of the content is stored in the memory of the content control apparatus or whether or not content stored in a storage medium is managed group by group.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A content control apparatus comprising:
a memory which stores storage medium information regarding a storage medium; and
a main control unit which groups a plurality of content items to be stored in the storage medium into a plurality of groups, allocates a group nonce to each group, stores the group nonce in the storage medium, and if a move of at least one content item of the plurality of content items is requested, controls the move of the content item based on whether the storage medium information contains an identifier or a group nonce of a first target group including the requested content item.

2. The content control apparatus according to claim 1, wherein if the move of the at least one content item of the plurality of content items is requested, the main control unit determines whether the storage medium information contains the identifier of the first target group, and if it is determined that the storage medium information contains the identifier of the first target group, the main control unit allows the move of the content item according to whether the group nonce of the first target group in the storage medium information is the same as the group nonce of the first target group stored in the storage medium.

3. The content control apparatus according to claim 2, wherein if the group nonce of the first target group in the storage medium information is the same as the group nonce of the first target group stored in the storage medium, the main control unit allows the move of the content item.

4. The content control apparatus according to claim 2, wherein if the content item is moved to another storage medium, the main control unit updates the group nonce of the first target group in the storage medium information and the group nonce of the first target group stored in the storage medium.

5. The content control apparatus according to claim 2, wherein if it is determined that the storage medium information does not contain the identifier of the first target group, the main control unit moves the content item to another storage medium.

6. The content control apparatus according to claim 5, wherein if the content item is moved to another storage medium, the main control unit updates the group nonce of the first target group stored in the storage medium, and adds the updated group nonce and the identifier of the first target group to the storage medium information and stores the updated storage medium information in the memory.

7. The content control apparatus according to claim 1, wherein initial information stored in the memory does not contain the group nonce of each group.

8. The content control apparatus according to claim 1, wherein if the content item is moved to another storage medium, the main control unit deletes the content item from the storage medium.

9. The content control apparatus according to claim 1, wherein if playback of the content item stored in the storage medium is requested, the main control unit determines whether the storage medium information stored in the memory contains an identifier of a second target group including the requested content item, and if it is determined that the storage medium information stored in the memory contains the identifier of the second target group and if a group nonce of the second target group in the storage medium information stored in the memory is the same as a group nonce of the second target group stored in the storage medium, the main control unit plays back the requested content item.

10. The content control apparatus according to claim 9, wherein if the storage medium information stored in the memory does not contain the identifier of the second target group, the main control unit plays back the requested content item.

11. A content controlling method comprising:
grouping a plurality of content items to be stored in a storage medium into a plurality of groups, generating a group nonce for each group, and storing the group nonce in the storage medium;
storing storage medium information regarding the storage medium in a memory; and
if a move of at least one content item of the plurality of content items is requested, controlling the move of the content item based on whether the storage medium information contains an identifier or a group nonce of a first target group including the requested content item.

12. The method according to claim 11, wherein the controlling the move of the content item comprises:
if the move of the at least one content item of the plurality of content items is requested, determining whether the storage medium information contains the identifier of the first target group; and
if it is determined that the storage medium information contains the identifier of the first target group, allowing the move of the content item according to whether the group nonce of the first target group in the storage medium information is the same as the group nonce of the first target group stored in the storage medium.

13. The method according to claim 12, wherein in the allowing the move of the content item, if the group nonce of the first target group in the storage medium information is the same as the group nonce of the first target group stored in the storage medium, the move of the content item is allowed.

14. The method according to claim 12, further comprising:
moving the content item to another storage medium; and
updating the group nonce of the first target group in the storage medium information and the group nonce of the first target group stored in the storage medium.

15. The method according to claim 12, further comprising:
if it is determined that the storage medium information does not contain the identifier of the first target group, moving the content item to another storage medium.

16. The method according to claim 15, further comprising, after the moving the at least one content item:
updating the group nonce of the first target group stored in the storage medium; and
adding the updated group nonce and the identifier of the first target group to the storage medium information and storing the updated storage medium information in the memory.

17. The method according to claim 11, wherein information stored in the memory prior to the move of the content item does not contain the group nonce of each group.

18. The method according to claim 11, further comprising:
if the content item is moved to another storage medium, deleting the content item from the storage medium.

19. The method according to claim 11, further comprising:
if playback of the content item stored in the storage medium is requested, determining whether the storage medium information stored in the memory contains an identifier of a second target group including the requested content item;
if it is determined that the storage medium information stored in the memory contains the identifier of the second target group, determining whether a group nonce of the second target group in the storage medium information stored in the memory is the same as a group nonce of the second target group stored in the storage medium; and
if it is determined that the group nonce of the second target group in the storage medium information stored in the memory is the same as the group nonce of the second target group stored in the storage medium, playing back the requested content item.

20. The method according to claim 19, further comprising:
if it is determined that the storage medium information stored in the memory does not contain the identifier of the second target group, playing back the requested content item.

21. A content controlling method comprising:
storing a group identified (ID) and first group nonce value in association with a content item of a group of content items on a first storage medium;
storing the group ID and a second group nonce value in association with a first storage medium ID on a control storage medium, the second group nonce value having an initial value equal to the first group nonce value;
receiving a request to move the content item to a second storage medium;
copying the content item and associated group ID and first group nonce value to the second storage medium and deleting the content item and associated group ID and first group nonce value from the first storage medium;
changing the second group nonce value; and
determining whether to allow operations on the content item based on a comparison of the first group nonce value and the second group nonce value.

22. A content control apparatus comprising:
a first storage medium storing a group ID and a first group nonce value in association with each of a plurality of content items of a group of content items;
a control storage medium storing the group ID and a second group nonce value in association with a first storage medium ID;
wherein the first group nonce value associated with each of the plurality of content items and the second group nonce value are changed to a new value after a content item stored on the first storage medium is moved to a second storage medium; and
wherein playback of content items having a first group nonce value different than the second group nonce value is denied.
